(19) United States
(12) Patent Application Publication
(10) Pub. No.: US 2026/0346248 A1
(43) Pub. Date: Nov. 5, 2026

(54) Microfluidic Device

(71) Applicant: Robert Bosch GmbH, Stuttgart (DE)

(72) Inventors: Anja Lippert, Leonberg (DE); Aaron Doerr, Leonberg (DE); Julian Kassel, Pforzheim (DE); Ronny Leonhardt, Gerlingen (DE)

(21) Appl. No.: 19/107,994

(22) PCT Filed: Aug. 31, 2023
(86) PCT No.: PCT/EP2023/073865

§ 371 Date: Feb. 28, 2025

(30) Foreign Application Priority Data
Sep. 9, 2022 (DE) 10 2022 209 416.6

(51) Int. Cl. B01L 3/00

(52) U.S. Cl. CPC B01L 3/502746; B01L 2300/0819; B01L 2400/086

(57) ABSTRACT

A microfluidic device, having an array chamber, the lower face of which is equipped with an array, and a feed region, which opens into the array chamber and which is designed to introduce a fluid into the array chamber along a flow direction. At least one protrusion on the upper face of the array chamber protrudes into the array chamber between the array and the feed region.

The present invention relates to a microfluidic device comprising an array chamber. The invention further relates to a use of the microfluidic device.

### PRIOR ART

Microfluidic analysis systems, which can also be referred to as lab-on-chip systems, enable automated processing of chemical or biological substances for medical diagnostics. For this purpose, they often have, as a sample carrier, an array comprising a plurality of blind hole-shaped wells with dried reagents pre-stored. Such an array is described in DE 10 2019 220 017 A1.

The array is flushed with a reaction fluid and the wells are filled in this manner. The wells can then be isolated from one another by means of a sealing fluid. After the sealing fluid has been introduced, chemical reactions take place in the wells between the reaction fluid and the pre-stored reagents. The chamber in which the array is arranged is optically accessible so that the results of the reactions can be evaluated by means of an optical sensor.

### DISCLOSURE OF THE INVENTION

The microfluidic device comprises an array chamber with an array arranged at the lower face. An array is understood to mean an element having a plurality of blind-hole-shaped wells on its upper face. In particular, reagents are arranged in the wells. In particular, the array comprises silicon, or is preferably configured as a silicon chip.

A supply region opening into the array chamber is configured in order to introduce a fluid, in particular a chemical or biological reaction fluid, into the array chamber along a flow direction. The filling of the wells by the fluid must occur in a reproducible and controlled manner. Only thus can it be ensured that chemical reactions take place in the wells reproducibly and with sufficient yield. Decisive for filling the wells is the progression of an interface between air and the fluid on the array. This progression is significantly influenced by geometric dimensional deviations and local surface properties of the array, and by properties of the flow of the array. These can lead to unforeseen fluctuations in the movement of the interface and thus indirectly to fluctuations in the reaction yield of chemical reactions in the wells. For example, increased wetting along the central axis of the array and/or increased lateral wetting may occur, which poses the risk of air pockets in adjacent corners of the array chamber, as well as incomplete wetting of the array.

To reduce this risk, it is provided that, at an upper face of the array chamber, at least one protrusion protrudes into the array chamber between the array and the feed region. This protrusion has a slowing effect on the three-phase contact line between the incoming fluid, the array chamber wall, and the air displaced by the fluid and the fluid located in the array chamber. This results in a compensating effect on the flow of the fluid in the lateral direction, i.e. orthogonal to the flow direction. This is based on the phenomenon of contact line pinning.

In order to be able to counteract both a possible strengthened wetting of the array along the central axis of the array and a possible strengthened lateral wetting, it is preferred that the protrusion extends over a whole width of the feed region. If the width of the feed region at its transition into the array chamber corresponds to the width of the array chamber, this means that the protrusion extends across the whole width of the array chamber. However, if the feed region at its transition into the array chamber is narrower than the array chamber, it is sufficient for the width of the protrusion to correspond to the width of this transition.

In one embodiment of the microfluidic device, the protrusion extends orthogonally to the flow direction. This means that it extends parallel to an edge of the array that faces the feed region. This shape of the protrusion is preferred when a best possible homogenization of the fluid flow is to be achieved.

In a further preferred embodiment of the microfluidic device, the protrusion is V-shaped or circular-segment-shaped. In a V-shaped embodiment, a tip of the V-shape faces the array along the flow direction. In a circular segment-shaped embodiment, an apex of the circular segment shape faces the array along the flow direction. By means of these shapes of the protrusion, a targeted flow guide is possible. This can be particularly advantageous when a sharp change in the flow of the incoming fluid is desired, due to an unusual geometry of the array chamber and/or the feed region.

It has been shown that a rectangular, triangular, or semi-circular cross-section of the protrusion is particularly advantageous for the flow direction of the fluid.

A height of the protrusion is preferably at least 10 μm. At a lower height, only a weak engagement with the fluid flow could be achieved.

Furthermore, it is preferred that the height of the protrusion is at most 10% of a height of the array chamber. The height of the array chamber is understood to mean the distance from an upper face of the array to an upper face of the array chamber. At a greater height of the protrusion, there is a risk that the main flow of the fluid will be adversely affected, which would have a negative impact on the filling of the wells of the array.

A length of the protrusion along the flow direction is limited by the available design space and conditions of manufacturing of the microfluidic device. Preferably, a length of the protrusion corresponds to a maximum of its height, more preferably precisely its height. A rectangular cross-section of the protrusion is therefore designed in particular as a square cross-section, and a triangular cross-section of the protrusion is designed in particular in the form of an equilateral triangle. The length of the protrusion is understood to mean its dimension in the flow direction, wherein the length on the contact surface of the protrusion is measured with the upper face of the array chamber. For a protrusion having a triangular or semicircular cross-section, the length measurement takes place at its largest dimension. The length of a protrusion having a semicircular cross-section corresponds to the diameter of the semicircle.

Preferably, the microfluidic device comprises a plurality of protrusions. These are arranged successively in the flow direction. Further protrusions serve as a reserve if a meniscus of the fluid front was not yet able to be stopped by the first protrusion in the flow direction.

In particular, the microfluidic device may be a cartridge provided to be inserted into a microfluidic analysis system. In such a cartridge, reagents are pre-stored and a sample fluid is introduced into the cartridge. After performing chemical reactions and an analysis of the reaction result, the cartridge may be discarded as a disposable article, while other components of the analysis device, such as an optical sensor are reused.

In particular, such a cartridge comprises a fluidic layer, an elastomeric membrane, and a pneumatic layer. The fluidic layer is understood to mean a layer in which a fluid channel system is formed for conveying reagents and sample liquids in a substrate. The fluidic layer is separated from the pneumatic layer by the elastomeric membrane. In the pneumatic layer, there are pneumatic channels that open onto the elastomeric membrane. By applying a positive pressure to the pneumatic channels, the elastomeric membrane can be deflected into the fluidic layer, and by applying a negative pressure to the pneumatic channels, the elastomeric membrane can be deflected into the pneumatic layer.

In particular, the microfluidic device is configured to perform an amplification reaction, for example a PCR reaction or a rITA reaction, and can be used for this performance. Set-up is performed by pre-storing the reagents needed for the amplification reaction.

### BRIEF DESCRIPTION OF THE DRAWINGS

Exemplary embodiments of the invention are illustrated in the drawings and explained in more detail in the following description.

FIG. 1 shows an isometric view of an array chamber in a microfluidic device according to the prior art.

FIG. 2 shows an isometric view of an array chamber of a microfluidic device according to an exemplary embodiment of the invention.

FIG. 3 shows a cross-sectional view of a protrusion in a microfluidic device according to an exemplary embodiment of the invention.

FIG. 4 shows a cross-sectional view of a cutout of an array chamber in an exemplary embodiment of a microfluidic device according to the invention.

FIG. 5 shows a cross-sectional view of a protrusion in a microfluidic device according to a further exemplary embodiment of the invention.

FIG. 6 shows a cross-sectional view of a protrusion in a microfluidic device according to yet another exemplary embodiment of the invention.

FIG. 7 shows a cross-sectional view of an array chamber of a microfluidic device according to yet another exemplary embodiment of the invention.

### EXEMPLARY EMBODIMENTS OF THE INVENTION

FIG. 1 shows a cutout of a microfluidic device 10, which is designed e.g. as a disposable cartridge for an analysis system. In a fluidic layer of the microfluidic device 10, comprising for example a substrate made of polycarbonate in which channels and chambers are arranged, an array chamber 11 is arranged, among other things. An array 12 is arranged in the array chamber 11, being designed as a silicon chip, for example. It rests on the bottom of the array chamber 11 with its lower face and has wells (not shown) on its upper face, in which reagents are stored. A feed region 13 connected to a channel system of the fluidic layer (not shown) opens in the array chamber 11. A reaction fluid, which contains a biological sample, flows along a flow direction 20 through the feed region 13 and into the array 11. A fluid front 21 of the reaction fluid representing the interface between the reaction fluid and air contained in the array chamber 11 protrudes along a central axis of the flow. This results in uneven wetting of the upper face of the array 12 and thus an uneven filling of its wells.

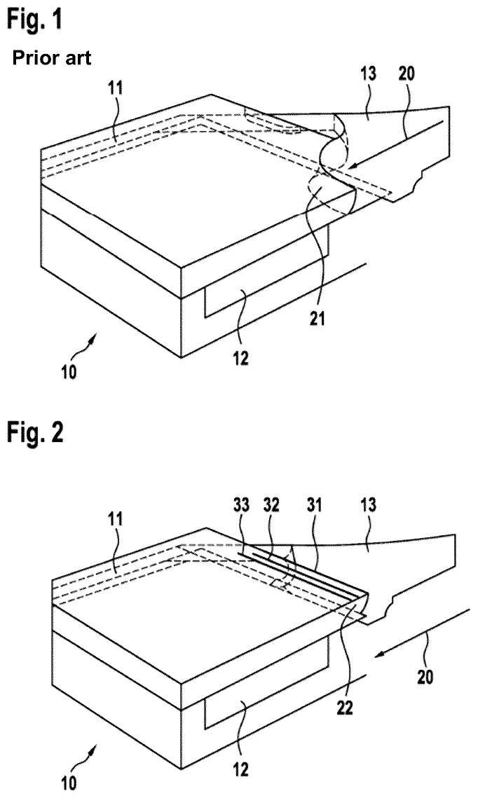

FIG. 2 shows how the array chamber 11 is designed in a microfluidic device 10 according to a first exemplary embodiment of the invention. In a region of the array chamber 11 that lies along the flow direction 20 behind the transition from the feed region 13 into the array chamber 11, but still before the array 12, three protrusions 31 to 33 are arranged on the upper face of the array chamber 11. The protrusions extend orthogonally to the flow direction 20 and orthogonally to the leading edge of the array 12, which faces the feed region 13. They are arranged consecutively and parallel to one another along the flow direction 20. Unlike the fluid front 21 in the array chamber 11 according to FIG. 1, a fluid front 22 of the reaction fluid, which represents the interface between the reaction fluid flowing in from the feed region 13 and air contained in the array chamber 11, does not protrude along the central axis of the flow, but rather runs evenly towards the array 12.

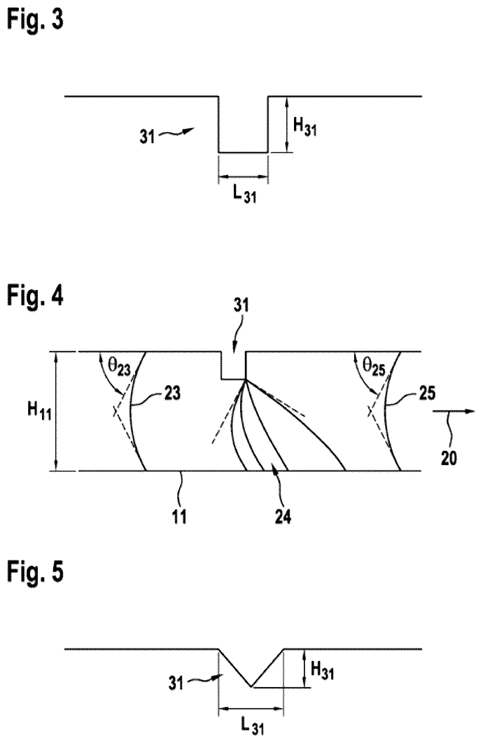

A cross-section of the first protrusion 31 is shown in FIG. 3. The protrusion 31 has a square cross-section. The length L₃₁ of the protrusion 31 along the flow direction 20 corresponds to its height H₃₁ and is, for example, 20 μm.

As shown in FIG. 4, the height H₁₁ of the array chamber 11 between its upper face and the upper face of the array 12 is, for example, 300 μm. The flow direction 20 is shown in FIG. 4 from left to right, wherein the bottom of the array chamber 11 transitions into the surface of the array 12 on the right outside of the region shown. The influence of the first protrusion 31 on the flow of the fluid is shown. A fluid front having a first meniscus 23 and a contact angle θ₂₃ opposite the upper face of the array chamber 11 flows into the array chamber 11 from the feed region 13. Contact with the first protrusion 31 results in a decrease in surface curvature due to contact line pinning, which is represented by a group of menisci 24 at the right corner of the protrusion 31. Here, the fluid pressure on the left side of the menisci 24 increases. The fluid flowing downstream from the left thus evades in the transverse direction, i.e. perpendicular to the drawing plane. This homogenized the forward movement of the fluid in the transverse direction. Thus, after passing through the protrusion 31, the newly formed meniscus 25 has a contact angle θ₂₅ which corresponds to the contact angle θ₂₃ of the meniscus 23 of the incoming fluid.

The cross-section of all three protrusions 31, 32, 33 corresponds in the first exemplary embodiment to the cross-section of the protrusion 31 as shown in FIG. 3. In a second exemplary embodiment of the microfluidic device 10, all three protrusions 31 to 33 have a cross-section shown for the first protrusion 31 in FIG. 5. The height H₃₁ of this protrusion corresponds to the height H₃₁ of the protrusion in the first exemplary embodiment of the microfluidic device 10. However, the cross-section is not square, but rather triangular.

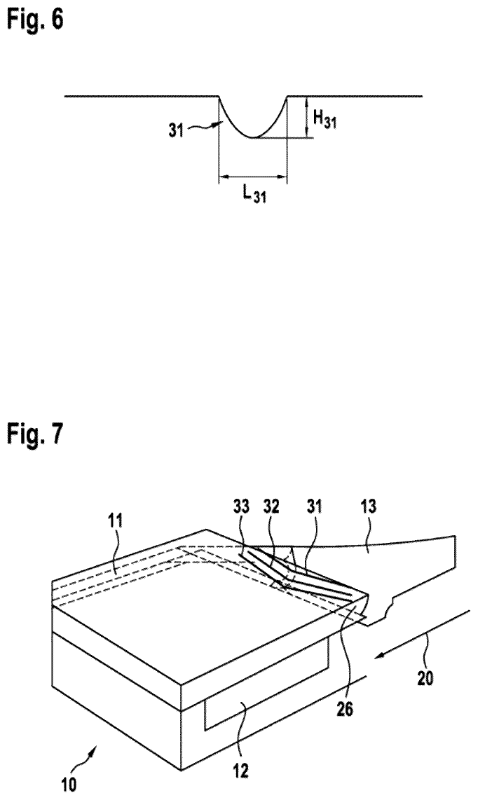

In a third exemplary embodiment of the microfluidic device 10, each of the three protrusions 31 to 33 has a semi-circular cross-section. This is shown in FIG. 6 for the first protrusion 31. The height H₃₁ corresponds to the height H₃₁ in the first exemplary embodiment of the invention. The length L₃₁ of the protrusion 31 corresponds to double the height H₃₁ and is thus 600 μm. The height H₃₁ matches the radius of the semicircle, and the length L₃₁ corresponds to its diameter.

In a fourth exemplary embodiment of the microfluidic device 10 shown in FIG. 7, the protrusions 31 to 33 extend non-orthogonally to the flow direction 20. Instead, they are each V-shaped. The tip of each V-shape faces away from the feed region 13 and faces the array 12. The cross-section of each of the protrusions 31-33 in this exemplary embodiment can correspond to each of the cross-sections shown in FIG. 3, FIG. 5, or FIG. 6. Like the fluid front 22 shown in FIG. 2, the fluid front 27 of the fourth exemplary embodiment also runs evenly towards the array 12.

1. A microfluidic device comprising:
an array chamber having an upper face and a lower face;
an array arranged in the array chamber; and
a feed region, which opens into the array chamber and which is designed to introduce a fluid into the array chamber along a flow direction; and
at least one protrusion located on the upper face of the array chamber and arranged to protrude into the array chamber between the array and the feed region.

2. The microfluidic device according to claim 1, wherein the at least one protrusion extends over a whole width of the feed region.

3. The microfluidic device according to claim 1, wherein the at least one protrusion extends orthogonally to the flow direction.

4. The microfluidic device according to claim 1, wherein:
the at least one protrusion is V-shaped or circular segment-shaped, and
a tip of the V-shape or an apex of the circular segment shape faces the array along the flow direction.

5. The microfluidic device according to claim 1, wherein the at least one protrusion has a rectangular, triangular, or semi-circular cross-section.

6. The microfluidic device according to claim 1, wherein the at least one protrusion has a height of at least 10 μm.

7. The microfluidic device according to claim 1, wherein the at least one protrusion has a height corresponding to a maximum of 10% of a height of the array chamber.

8. The microfluidic device according to claim 1, wherein the at least one protrusion has a length corresponding to a maximum of its height.

9. The microfluidic device according to claim 1, wherein the at least one protrusion comprises a plurality of protrusions arranged in succession along the flow direction.

10. A method comprising using the microfluidic device according to claim 1 in order to carry out an amplification reaction.

11. The microfluidic device according to claim 1, wherein the array is positioned to rest on the lower face of the array chamber.
